(19) United States
(12) Patent Application Publication
(10) Pub. No.: US 2023/0182458 A1
(43) Pub. Date: Jun. 15, 2023

(54) FILM STICKING TOOL AND FILM STICKING ASSEMBLY

(71) Applicant: Shenzhen Momi Electronic Technology Co., LTD., Shenzhen (CN)

(72) Inventor: Shengjie Zhou, Shenzhen (CN)

(21) Appl. No.: 17/549,857

(22) Filed: Dec. 13, 2021

(51) Int. Cl. B32B 37/00

(52) U.S. Cl. CPC B32B 37/0046; B32B 2457/208

(57) ABSTRACT

Disclosed are a film sticking tool and a film sticking assembly. The film sticking tool includes a film sticking box, the film sticking box includes a base assembly and a surface shell, the base assembly is provided with a positioning slot, the positioning slot is configured for positioning a device to be stuck with a film, the surface shell is configured for opening or covering the positioning slot, the surface shell is provided with a protective film mounting position for mounting a protective film assembly, a side wall of the film sticking box is provided with a drawing port, and the drawing port is configured for a drawing part on a release film layer of the protective film assembly to penetrate. The film sticking tool and a film sticking assembly provided by the technical schemes of the present invention are simple to operate, have high film sticking efficiency, and avoid the user from manually searching for the tear opening of the release film layer, which may cause impurities on hands to enter the adhesive surface of the protective film, thus generating bubbles between the protective film and the screen and affecting the display effect of the device stuck with a film.

### TECHNICAL FIELD

The present invention relates to the technical field of electronic product accessories, and in particular, to a film sticking tool and a film sticking assembly.

### BACKGROUND

With the continuous development of science and technology and the continuous improvement of living standards, mobile phones and other touch-screen-operated handheld electronic devices have become indispensable terminal devices in people's daily lives. Such electronic devices are prone to dust and stains on the screen during daily use. If it is used for a period of time or poorly protected, it will be scratched and become old. In order to prevent damage caused by frequent touches or external friction or collisions on the screen surface, most consumers choose to attach a protective film to the screen.

However, a release layer needs to be attached to an adhesive film of the protective film. The current film sticking tools generally require the user to manually find the tear opening of the release film layer, which is cumbersome to use and inefficient.

### SUMMARY

Aiming at improving the tearing efficiency of the release film layer on the protective film, the main objective of the present invention is to provide a film sticking tool.

In order to achieve the above objective, the film sticking tool provided by the present invention includes:

A base assembly and a surface shell, the base assembly is provided with a positioning slot, the positioning slot is configured for positioning a device to be stuck with a film, the surface shell is configured for opening or covering the positioning slot, the surface shell is provided with a protective film mounting position for mounting a protective film assembly, a side wall of the film sticking box is provided with a drawing port, and the drawing port is configured for a drawing part on a release film layer of the protective film assembly to penetrate.

Optionally, the base assembly includes a bottom shell and a positioning seat, the bottom shell has a mounting slot facing the surface shell, the positioning seat is arranged in the mounting slot, and the positioning slot is arranged on the positioning seat.

Optionally, the protective film mounting position is a placing slot formed on the surface shell.

Optionally, the drawing port includes a first notch arranged on a side wall of the surface shell and/or a second notch arranged on a side wall of the bottom shell; and/or

a slot bottom of the mounting slot is provided with an indication mark, indication mark is configured for indicating a mounting direction of the device to be stuck with a film, and the slot bottom of the positioning slot is provided with an avoidance opening, and the indication mark is exposed at the avoidance opening; and/or
the surface shell is provided with an operation port penetrating the protective film mounting position.

Optionally, the film sticking box has a first end and a second end opposite to each other, the surface shell is rotatably connected to the bottom shell at the first end of the film sticking box, and the drawing port is arranged at the second end of the film sticking box.

Optionally, the surface shell and the bottom shell are rotatably connected by a connector, and the surface shell, the connector and the bottom shell are integrally molded by injection molding, and at least a portion of the connector connected to the surface shell and the bottom shell is thinner than the surface shell and the bottom shell; and/or the surface shell is snap-connected to the bottom shell at the second end of the film sticking box.

Optionally, the surface shell is provided with a positioning structure at an edge of the protective film mounting position, and the positioning structure is configured for positioning and mounting the protective film assembly.

Optionally, the positioning structure includes a plurality of positioning protrusions, two opposite sides of the protective film mounting position are respectively provided with a part of the positioning protrusions, and at least one of the positioning protrusions is configured as a foolproof protrusion, and a cross-sectional size and/or a shape of the foolproof protrusion is different from other of the positioning protrusions.

Optionally, the foolproof protrusion is configured in a cylindrical shape or in a strip-shaped convex rib shape.

The present invention also provides a film sticking assembly, which includes:

the film sticking tool as mentioned above; and a protective film assembly, including a protective film and a release film layer, wherein the protective film and the release film layer are stacked, the release film layer is provided with a drawing part, one side of the release film layer away from the drawing port of the film sticking box of the film sticking tool is connected to one end of the drawing part, and the other end of the drawing part penetrates the drawing port.

The film sticking tool at least has the following beneficial effects.

According to the technical scheme of the present invention, a film sticking box is adopted; the film sticking box includes a base assembly and a surface shell; the base assembly is provided with a positioning slot for positioning the device to be stuck with a film; the surface shell is configured for opening or covering the positioning slot; the surface shell is provided with a protective film mounting position for mounting the protective film assembly; a side wall of the film sticking box is provided with a drawing port for the drawing part on the release film layer of the protective film assembly to penetrate. It can be understood that the purpose of providing the positioning slot is to prevent the device to be stuck with a film from shifting when the film is sticked, causing the protective film to tilt relative to the device to be stuck with a film, which will reduce the comfort of the user when using the device stuck with a film. Specifically, the protective film assembly is mounted in the protective film mounting position of the surface shell. Since the drawing port is arranged on the side wall of the film sticking box, the drawing part on the release film layer will automatically enter the drawing port when the protective film assembly is mounted, and the user does not need to pull the drawing part into the drawing port. Just by covering the surface shell on the base assembly, the drawing port is closed, and the drawing part will be difficult to fall out of the drawing port. At this time, the release film layer of the protective film assembly can be torn off by drawing the drawing part. It can be seen that such a film sticking assembly is easy to operate, has high film sticking efficiency, and avoids the user from manually searching for the tear opening of the release film layer, which may cause impurities on hands to enter the adhesive surface of the protective film, thus generating bubbles between the protective film and the screen and affecting the display effect of the device stuck with a film.

### BRIEF DESCRIPTION OF THE DRAWINGS

In order to describe the embodiments of the present invention or the technical schemes in the prior art more clearly, the drawings required in the description of the embodiments or the prior art will be briefly introduced below. Obviously, the drawings in the following description are only some embodiments of the present invention. For those of ordinary skill in the art, other drawings may be obtained according to the structures shown in these drawings without creative work.

FIG. 1 is a structural schematic diagram of a film sticking tool from a perspective according to an embodiment of the present invention;

FIG. 2 is a structural schematic diagram of the film sticking tool from another perspective;

FIG. 3 is an exploded structural schematic diagram of the film sticking tool from a perspective;

FIG. 4 is an exploded structural schematic diagram of the film sticking tool from another perspective;

FIG. 5 is a structural schematic diagram of the protective film of the film sticking assembly according to an embodiment of the present invention;

FIG. 6 is a structural schematic view the drawing part of the protective film of the film sticking assembly when the drawing part is unfolded; and

FIG. 7 is a exploded structural schematic diagram of the protective film of the film sticking assembly.

### DESCRIPTION OF REFERENCE NUMERALS

| Numeral | Name |
|---|---|
| 100 | Base assembly |
| 110 | Bottom shell |
| 111 | Mounting slot |
| 112 | Indication mark |
| 120 | Positioning seat |
| 121 | Positioning slot |
| 122 | Avoidance opening |
| 200 | Surface shell |
| 210 | Placing slot |
| 220 | Operation port |
| 230 | Positioning protrusion |
| 231 | Foolproof protrusion |
| 300 | Drawing port |
| 310 | First notch |
| 320 | Second notch |
| 400 | Connector |
| 500 | Protective film |
| 600 | Release film layer |
| 610 | Connecting protrusion |
| 611 | Folding line |
| 700 | Drawing part |
| 800 | Protective layer |
| 810 | Protective layer body |
| 820 | Positioning part |
| 821 | Positioning hole |
| 821a | Foolproof hole |

The implementation of the objectives, functional characteristics and advantages of the present invention will be further described in conjunction with the embodiments and with reference to the drawings.

### DETAILED DESCRIPTION

The technical schemes in the embodiments of the present invention will be clearly and completely described below with reference to the drawings in the embodiments of the present invention. Obviously, the described embodiments are only a part rather than all of the embodiments of the present invention. Based on the embodiments of the present invention, all other embodiments obtained by those of ordinary skill in the art without creative work shall fall within the protection scope of the present invention.

It should be noted that all directional indications (such as up, down, left, right, front, back, . . . ) in the embodiment of the present invention are only intended to explain a relative position relationship and a movement situation among components in a certain specific posture (as shown in the drawings), and if the specific posture changes, the directional indications will change accordingly.

In the present invention, unless otherwise clearly specified and limited, the terms “connected”, “fixed”, and the like should be understood in a broad sense. For example, “fixed” can mean a fixed connection, a detachable connection, or a whole; it can mean a mechanical connection or an electrical connection; it can mean direct connection or indirect connection through an intermediate medium; and it can mean internal communication between two elements or an interaction relationship between two elements, unless otherwise explicitly limited. For those of ordinary skill in the art, the specific meanings of the above-mentioned terms in the present invention can be understood according to specific circumstances.

In addition, if there are descriptions related to “first” and “second” in the embodiments of the present invention, the descriptions of the “first” and “second” are only configured for the objective of description, and cannot be understood as indicating or implying their relative importance or implicitly indicating the number of indicated technical features. Therefore, the features defined with “first” and “second” may explicitly or implicitly include at least one of the features. In addition, the meaning of “and/or” appears in the text includes three parallel schemes, for example, “A and/or B” includes scheme A, scheme B, or a scheme including both scheme A and scheme B. In addition, the technical schemes among the various embodiments may be combined with each other, but they must be based on the implementation by those of ordinary skill in the art. When the combination of technical schemes is contradictory or impossible to implement, it should be considered that such a combination of technical schemes does not exist, nor is it within the protection scope claimed by the present invention.

The present invention provides a film sticking tool.

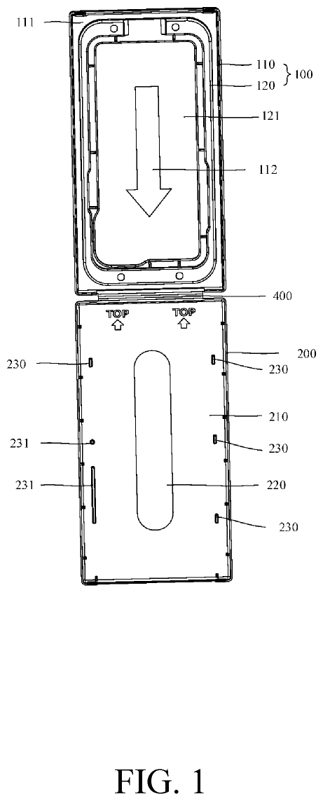

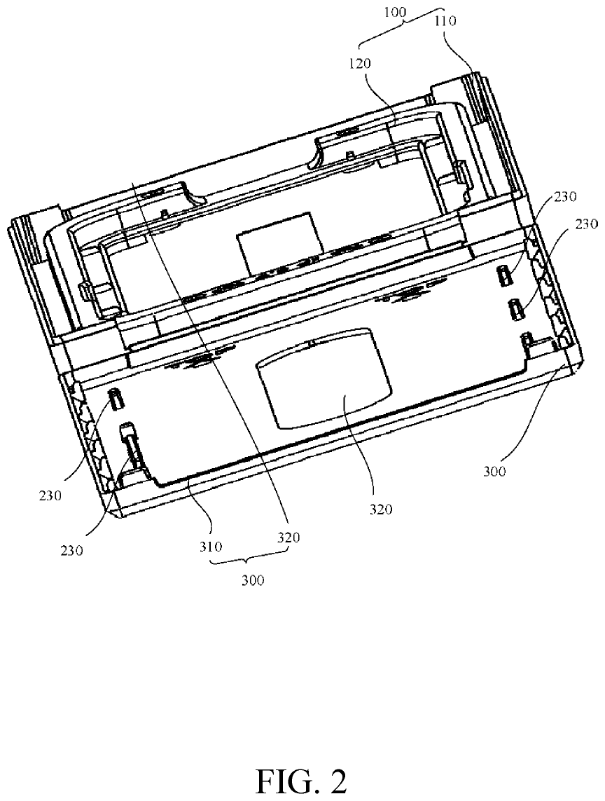

Referring to FIGS. 1 and 2, in an embodiment of the present invention, the film sticking tool includes a film sticking box. The film sticking box includes a base assembly 100 and a surface shell 200. The base assembly 100 is provided with a positioning slot 121 for positioning the device to be stuck with a film, and the surface shell 200 is configured for opening or covering the positioning slot 121. The surface shell 200 is provided with a protective film mounting position for mounting the protective film assembly. A side wall of the film sticking box is provided with a drawing port 300 for the drawing part 700 on the release film layer 600 of the protective film assembly to penetrate.

Specifically, when the protective film assembly is mounted in the protective film mounting position of the surface shell, since the drawing port 300 is arranged on the side wall of the film sticking box, the drawing part 700 on the release film layer 600 will automatically enter the drawing port 300 while mounting the protective film assembly, so that the user does not need to pull the drawing part 700 into the drawing port 300. Just by covering the surface shell on the base assembly, the drawing port is closed, and the drawing part will be difficult to fall out of the drawing port. At this time, the release film layer of the protective film assembly can be torn off by drawing the drawing part. It can be seen that such a film sticking assembly is easy to operate, has high film sticking efficiency, and avoids the user from manually searching for the tear opening of the release film layer 600, which may cause impurities on hands to enter the adhesive surface of the protective film 500, thus generating bubbles between the protective film 500 and the screen and affecting the display effect of the device stuck with a film.

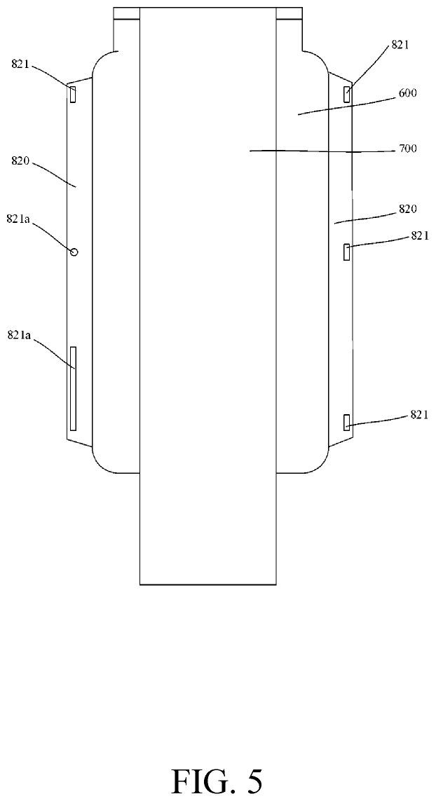

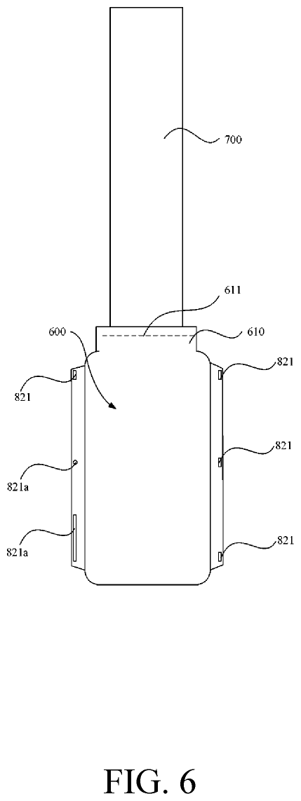

Referring to FIGS. 5 and 6, optionally, in an embodiment of the present invention, the protective film assembly includes a protective film 500, a release film layer 600 and a drawing part 700. The protective film 500 has a sticking surface for attaching to the device to be stuck with a film. The release film layer 600 is arranged on the sticking surface, and the release film layer 600 has a first end and a second end which are opposite to each other. One end of the drawing part 700 is connected to the first end of the release film layer 600, the other end of the drawing part 700 extends towards the second end of the release film layer 600, and the drawing part 700 has an extension section extending out of the second end of the release film layer 600. The drawing part 700 is configured for tearing off the release film layer 600.

Specifically, one end of the drawing part 700 is connected to the first end of the release film layer 600, and the other end of the drawing part 700 extends towards the second end of the release film layer 600, and the drawing part 700 has an extension section extending out of the second end of the release film layer 600, so that the release film layer 600 can be separated from the protective film 500 only by pulling the drawing part 700. The extension section can make the drawing part 700 more convenient to hold and find, making the operation faster. The drawing part 700 makes the separation operation of the release film layer 600 from the protective film 500 simple, improves the separation rate, thereby improves the film sticking efficiency. And it also avoids the user from manually searching for the tear opening of the release film layer 600, which may cause impurities on the hands to enter the sticking surface of the protective film 500, thereby generating bubbles between the protective film 500 and the screen of the device to be stuck with a film and affecting the display effect of the device to be stuck with a film. It can be seen that the sticking operation steps proposed in this technical scheme are simple, fast and convenient, and the protective film 500 and the screen of the device to be stuck with a film are not prone to generate bubbles, thus improving the attaching effect.

Further, the first end of the release film layer 600 is provided with a connecting protrusion 610, and the drawing part 700 is connected to the connecting protrusion 610. The connecting protrusion 610 makes the connection between the drawing part 700 and the release film layer 600 more stable. Of course, the present invention is not limited to this. In other embodiments, the drawing part 700 can also be directly connected to the release film layer 600.

Optionally, the connecting protrusion 610 is provided with a folding line 611, and a portion of the connecting protrusion 610 can be bent along the folding line 611, and the bent portion is connected to the drawing part 700; and/or, the extension section of the drawing part 700 is provided with an indication mark (not shown), and the pointing direction of the indication mark is away from the first end of the release film layer 600.

Specifically, in an embodiment, the connecting protrusion 610 is provided with a folding line 611, and a portion of the connecting protrusion 610 can be bent along the folding line 611, and the bent portion is connected to the drawing part 700. The folding line 611 can facilitate the drawing part 700 to be laminated on the surface of the release film layer 600, and avoid the separation of the release film layer 600 from the protective film 500 during lamination, resulting in dust being attached to the sticking surface of the protective film 500, and generating bubbles when sticking the film to the device to be stuck with a film. Besides, a portion of the connecting protrusion 610 can be bent along the folding line 611, and the bent portion can be connected to the drawing part 700, thus avoiding bending at the lamination position of the drawing part 700 and the release film layer 600, which affects the stability of the connection between the drawing part 700 and the release film layer 600. Of course, the present invention is not limited to this, and in other embodiments, the folding line 611 can also be arranged on the drawing part 700.

Further, the folding line 611 is a discontinuous cutting line, which is simple in structure and convenient to fold, and when the drawing part 700 is not needed, the drawing part 700 can be torn off by the discontinuous cutting line. Of course, the present invention is not limited to this. In other embodiments, the folding line 611 can also be thinned at the connection between the release film layer 600 and the drawing part 700, so as to form the folding line 611 at the connection between the release film layer 600 and the drawing part 700.

Optionally, the extension section of the drawing part 700 is provided with an indication mark, and the pointing direction of the indication mark is away from the first end of the release film layer 600. The indication mark can guide the user to pull the drawing part 700 in a right direction, so as to prevent the user from pulling in a wrong direction, which may cause damage such as breakage or crease of the protective film 500.

Further, the indication mark may be a pattern depicted in color, or the shape of the extended section of the drawing part 700 may be in the shape of an arrow.

Optionally, that width of the drawing part 700 is smaller than the width of the release film layer 600. The arrangement that the width of the drawing part 700 is smaller than the width of the release film layer 600 can reduce the material of the drawing part 700 and reduce the production cost. Further, in an embodiment, the width of the drawing part 700 is three-quarters of the width of the release film layer 600, which can increase the stressed area of the drawing part 700 and the release film layer 600, and also increase the holding area of the drawing part 700 when held by the user, thus facilitating the tearing of the release film layer 600 and the protective film 500. Of course, the present invention is not limited to this. In a second embodiment, the width of the drawing part 700 is two-thirds of the width of the release film layer 600. And of course, the present invention is not limited to this. In a third embodiment, the width of the drawing part 700 is half of the width of the release film layer 600. Of course, the present invention is not limited to this. In a fourth embodiment, the drawing part 700 can also be a thin wire.

Further, the mode of connection between the drawing part 700 and the release film layer 600 is bonding, or the drawing part 700 and the release film layer 600 are integrally molded.

It should be noted that, in an embodiment, the mode of connection between the drawing part 700 and the release film layer 600 is bonding, which has the advantages of simple process, low manufacturing cost and smooth bonded joints. Moreover, the bonding mode does not limit the materials of the release film layer 600 and the drawing part 700, and the materials of the release film layer 600 and the drawing part 700 can be arbitrarily exchanged, thus increasing the convenience of processing. In the second embodiment, the drawing part 700 and the release film layer 600 are integrally molded. The integrally molded product has good integrity, reduces the connection process of the release film layer 600 and the drawing part 700, and makes the manufacturing process and mounting procedure more convenient and faster.

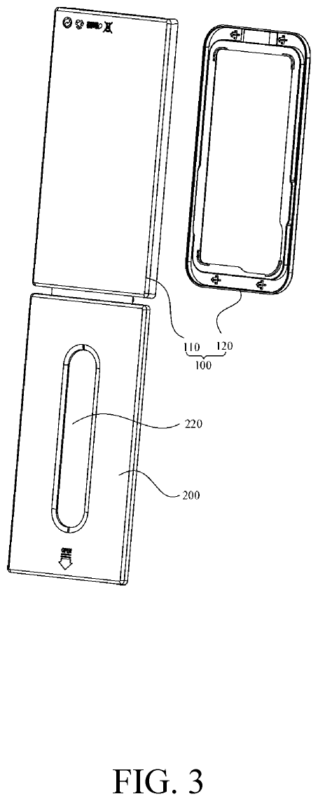

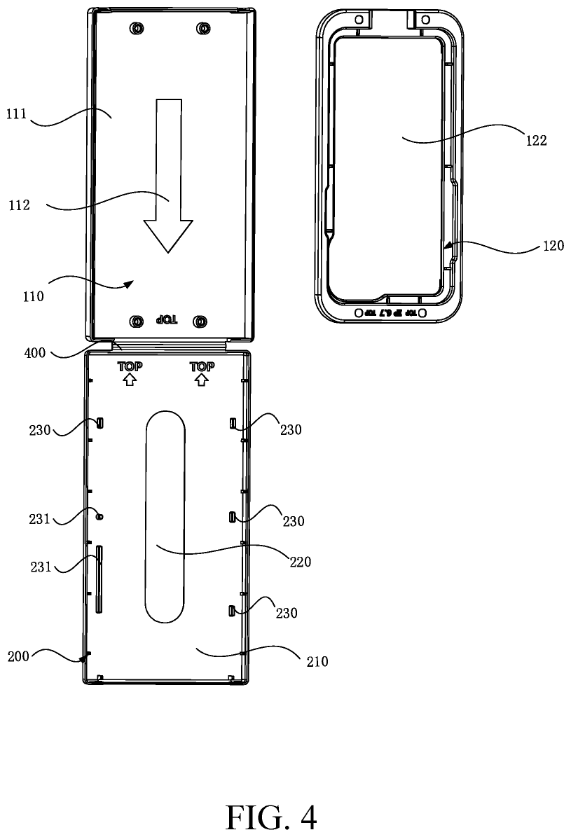

Referring to FIGS. 2 to 4, optionally, the base assembly 100 includes a bottom shell 110 and a positioning seat 120, the bottom shell 110 has a mounting slot 111 facing the surface shell 200, the positioning seat 120 is arranged in the mounting slot 111, and the positioning slot 121 is arranged on the positioning seat 120. Specifically, the positioning seat 120 can be detachably mounted on the bottom shell 110, and the base assembly 100 can be divided into the bottom shell 110 and the positioning seat 120. The purpose of this arrangement is to facilitate the user to adapt and change according to the size and appearance of the mobile phones or tablets or other device to be stuck with a film. Therefore, the positioning seat 120 can be designed in a variety of styles, and each type of positioning seat 120 corresponds to a style of device to be stuck with a film, so that the device to be stuck with a film can just fit into the positioning seat 120 to increase the stability of the device to be stuck with a film. Of course, the present invention is not limited to this. In the second embodiment, the bottom shell 110 and the positioning seat 120 can also be integrally molded. Of course, the present invention is not limited to this. In the second embodiment, the bottom shell 110 and the positioning seat 120 can also be connected into a whole by bonding.

Further, the bottom shell 110 is provided with a plurality of clamping slots, and the bottom of the positioning seat 120 is provided with clamping protrusions corresponding to the clamping slots, so that the positioning seat 120 can be mounted on the bottom shell 110. In this way, the positioning seat 120 and the bottom shell 110 can be easily mounted and disassembled, can be disassembled without tools, and does not need additional materials such as screw fasteners during the mounting process. The mounting process of the snap is very simple, generally only one piercing action is needed, and there is no need for rotating movement or product positioning before mounting, which is quick and convenient. Of course, the present invention is not limited to this. In some other embodiments, the bottom of the positioning seat 120 may be provided with a plurality of clamping slots, and the bottom shell 110 may be provided with clamping protrusions corresponding to the clamping slots.

Further, the clamping slots can be hollow mounting posts, and the clamping protrusions can be clamped into the cavities of the mounting posts. In other embodiments, the clamping slots can also be clamping holes formed in the bottom shell 110, and the clamping protrusions can be clamped into the clamping holes.

Further, one end of the clamping slots facing the positioning seat 120 is provided with a guide slope to guide the insertion of the clamping protrusions on the positioning seat 120. Of course, the present invention is not limited to this, and in other embodiments, a guiding inclined surface can also be provided on the free ends of the clamping protrusions.

Optionally, the protective film mounting position is a placing slot 210 formed on the surface shell 200 for mounting the protective film assembly. Specifically, after the surface shell 200 is covered on the base assembly 100, a placing slot 210 is formed on one side of the surface shell 200 close to the base assembly 100. The placing slot 210 is a protective film mounting position, the protective film is mounted in the protective film assembly mounting position, and the device to be stuck with a film is mounted in the mobile phone positioning slot 121 on the positioning seat 120. At this time, the protective film 500 is located above the screen of the device to be stuck with a film, so as to realize the sticking of the protective film 500 to the device to be stuck with a film. Of course, the present invention is not limited to this. In other embodiments, there may be a certain interval between the surface shell 200 and the base assembly 100 as the protective film mounting position.

Further, the end of the slot wall of the mounting slot 111 close to the surface shell 200 is provided with a convex ring. The inner slot wall of the placing slot 210 is provided with a plurality of limit posts corresponding to the convex rings, and limit posts have connecting sections and limit sections. A limit slot is formed between the limit posts and the slot wall of the mounting slot 111, and the convex ring is placed in the limit slot. The purpose of this arrangement is to prevent the base assembly 100 from shifting from the surface shell 200.

Optionally, the drawing port 300 includes a first notch 310 arranged on the side wall of the surface shell 200 and/or a second notch 320 arranged on the side wall of the bottom shell 110; and/or, the bottom of the mounting slot 111 is provided with an indication mark 112 for indicating the mounting direction of the device to be stuck with a film, the bottom of the positioning slot 121 is provided with an avoidance opening 122, and the indication mark 112 is exposed at the avoidance opening 122; and/or, the surface shell 200 is provided with an operation port 220 penetrating the protective film mounting position.

Further, in an embodiment, the operation port 220 is in a “I” shape; in the second embodiment, the operation port 220 can also be in an arrow shape; in the third embodiment, the operation port 220 can also be in a “T” shape; and in the fourth embodiment, the operation port 220 can be in other shapes that can facilitate pressing and expelling bubbles, which is not specifically limited here.

Specifically, in an embodiment, the drawing port 300 includes the first notch 310 arranged on the side wall of the surface shell 200 and the second notch 320 arranged on the side wall of the bottom shell 110. The purpose of this arrangement is to increase the hole size of the drawing port 300, which is beneficial to make the drawing of the release film layer 600 of the protective film assembly more convenient and faster. Of course, the present invention is not limited to this. In the second embodiment, the drawing port 300 may only include the first notch 310 arranged on the side wall of the surface shell 200. Of course, the present invention is not limited to this. In the third embodiment, the drawing port 300 may only include the second notch 320 arranged on the side wall of the bottom shell 110.

Further, in an embodiment, the bottom of the mounting slot 111 is provided with an indication mark 112 for indicating the mounting direction of the device to be stuck with a film, the bottom of the positioning slot 121 is provided with an avoidance opening 122, and the indication mark 112 is exposed at the avoidance opening 122. The indication mark 112 can increase the user's recognition of the direction of the film sticking box, so that the user can quickly and accurately fix the device to be stuck with a film on the positioning seat 120. Of course, the present invention is not limited to this. In other embodiments, the indication mark 112 can also be arranged on the positioning seat 120.

Further, the indication mark 112 is a concave indication mark arrow. Such an indication mark 112 has high practicability and will not be blurred due to abrasion even after repeated use. Of course, the present invention is not limited to this. In other embodiments, the indication mark 112 can also be an indication mark arrow or text description depicted in color.

Further, it is considered here that after the device to be stuck with a film is placed in the positioning slot 121, and after film sticking to the device to be stuck with a film is completed, it is difficult to take the device to be stuck with a film, and it is necessary to turn over the film sticking tool of the device to be stuck with a film out of the device to be stuck with a film, or pull out the device to be stuck with a film along the side wall of the device to be stuck with a film, which is very inconvenient. In view of this, in order to solve this problem, the edge of the positioning seat 120 can be provided with an avoidance slot, and when the user takes the device to be stuck with a film, the device to be stuck with a film in the positioning slot 121 can be conveniently taken out through the avoidance slot.

Further, in an embodiment, the surface shell 200 is provided with an operation port 220 penetrating the protective film mounting position, and the operation port 220 is configured for pressing the protective film 500 by the user's hand to stick the protective film 500 on the device to be stuck with a film. The film sticking method is simple and easy to operate, and it is not prone to generate bubbles between the protective film 500 and the screen of the device to be stuck with a film, which may affect the display effect of the device to be stuck with a film.

As for the type of the protective film 500, it may be a peep-proof film, a high-permeability scratch-proof film, a diamond film, a frosted film, a blue light-proof film, and the like. As for the material of the protective film 500, it may be a PC protective film, a PVC protective film, a PET protective film, an AR protective film, a screen-printed full-screen tempered glass film and the like, the color and type of protective film 500 are not specifically limited here.

Optionally, the film sticking box has a first end and a second end which are opposite to each other. At the first end of the film sticking box, the surface shell 200 is rotatably connected to the bottom shell 110, and the drawing port 300 is arranged at the second end of the film sticking box. The surface shell 200 is rotatably connected to the bottom shell 110, so that the surface shell 200 can be turned over relative to the bottom shell 110. This design can avoid the assembly trouble between the base assembly 100 and the surface shell 200, and also can prevent the user from losing either the base assembly 100 or the surface shell 200 and being unable to use the film sticking tool, thus causing unnecessary waste. Of course, the present invention is not limited to this. In other embodiments, the first end of the film sticking box, the surface shell 200 and the bottom shell 110 can also be detachably connected.

Optionally, the surface shell 200 and the bottom shell 110 are rotatably connected by a connector 400, and the surface shell 200, the connector 400 and the bottom shell 110 are integrally molded by injection molding. And at least a portion of the connector 400 connected to the surface shell 200 and the bottom shell 110 is thinner than the surface shell 200 and the bottom shell 110; and/or the surface shell 200 is snap-connected to the bottom shell 110 at the second end of the film sticking box.

Specifically, in an embodiment, the surface shell 200 and the bottom shell 110 are rotatably connected by the connector 400, and the surface shell 200, the connector 400 and the bottom shell 110 are integrally molded by injection molding. And at least a portion of the connector 400 connected to the surface shell 200 and the bottom shell 110 is thinner than the surface shell 200 and the bottom shell 110. In this way, there is no need to design two molds for the bottom shell 110 and the face shell 200 of the film sticking box, so that the mold design can be simplified, the manufacturing process of the film sticking box can be reduced, and the production efficiency can be effectively improved. Of course, the present invention is not limited to this. In other embodiments, the surface shell 200 and the bottom shell 110 are rotatably connected by a hinge.

Further, in an embodiment, at the second end of the film sticking box, the surface shell 200 is snap-connected to the bottom shell 110. In this way, the protective film 500 can be more attached to the device to be stuck with a film, which is convenient for the user to stick the film, and also avoids the deviation of the end away from the rotary connection, which causes the protective film 500 to deviate from the device to be stuck with a film. Moreover, the mounting process of the snap of the snap-connection is very simple, generally only one piercing action is needed, and there is no need for rotating movement or product positioning before mounting, which is quick and convenient.

Optionally, the surface shell 200 is provided with a positioning structure at the edge of the protective film mounting position, and the positioning structure is configured for positioning and mounting the protective film assembly. The positioning structure is beneficial for positioning the protective film assembly in cooperation with the positioning part 820 on the protective film assembly, avoiding the shifting of the protective film assembly relative to the device to be stuck with a film, realizing accurate positioning of the protective film assembly and avoiding damaging the protective film 500.

Optionally, the positioning structure includes a plurality of positioning protrusions 230. The opposite sides of the protective film mounting position are respectively provided with a part of the positioning protrusions 230, and at least one positioning protrusion 230 is configured as a foolproof protrusion 231. The cross-sectional size and/or shape of 231 is different from that of other positioning protrusions 230. The foolproof protrusion 231 can prevent the user from mounting the protective film assembly in a reverse order. Further, the positioning protrusion 230 has a simple structure and is convenient for processing.

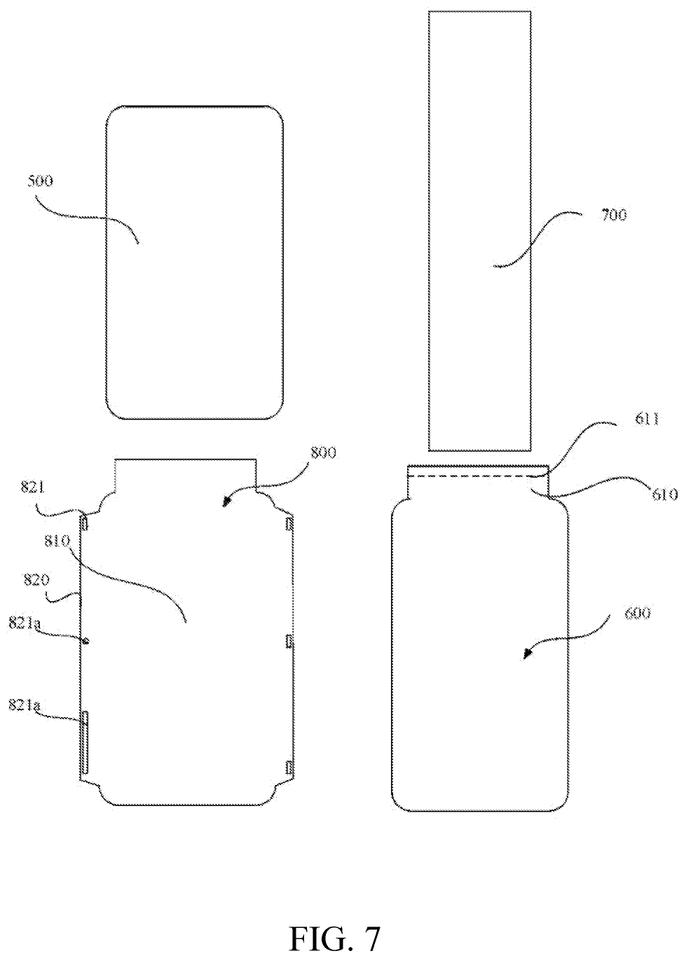

Referring to FIG. 7, optionally, the protective film assembly further includes a protective layer 800, the protective layer 800 is arranged on the surface of the protective film 500 facing away from the release film layer 600. The protective layer 800 can prevent impurities such as dust from adhering to the surface of the protective film 500, and can also prevent hard objects from scratching the protective film 500. Of course, the present invention is not limited to this. In other embodiments, the protective layer 800 can also be an anti-oxidation layer to avoid premature aging of the protective film assembly when they are not used.

Optionally, the protective layer 800 includes a protective layer body 810 covering the protective film 500, and a positioning part 820 extending out of the protective layer body 810. The positioning part 820 is provided with a plurality of positioning holes 821, the positioning holes 821 are configured for positioning the protective film assembly in cooperation with the film sticking tool. The film sticking tool is provided with a positioning structure corresponding to the positioning holes 821, so that the protective film 500 can be prevented from moving when sticking the film, for example but not limited to, when pressing the protective film 500 when separating the release film layer 600 from the protective film 500 by using the drawing part 700. It can be understood that when the protective film 500 deviates from the device to be stuck with a film, the display effect of the device to be stuck with a film will be affected, and the user's comfort will be affected. Moreover, the positioning part 820 gives the user a holding point on the protective layer 800, which is beneficial for the user to separate the protective layer 800 from the protective film 500, avoiding the user from manually searching for the separation starting point, and increasing the film sticking efficiency. It can be seen that the positioning part 820 can not only position the protective film 500, but also improve the film sticking efficiency.

Optionally, the positioning parts 820 are arranged on the opposite sides of the protective layer body 810, and the positioning parts 820 on both sides are respectively provided with some of the positioning holes 821, and the positioning holes 821 are arranged on the positioning parts 820 at intervals. The positioning parts 820 are arranged on the opposite sides of the protective layer body 810, so that the opposite sides of the protective film assembly can be fixed, the stress of the protective film assembly can be balanced, and the positioning stability of the protective film assembly can be increased. Of course, the present invention is not limited to this. In other embodiments, the positioning parts 820 can also be arranged at two adjacent sides of the protective layer body 810.

Optionally, at least one positioning hole 821 is configured as a foolproof hole 821a, and the size and/or shape of the foolproof hole 821a is different from those of other positioning holes 821. With the foolproof structure, when mounting the protective film assembly in a reverse order, the sticking film will not be mounted in the protective film mounting position of the film sticking tool, thus preventing the user from mounting the protective film 500 in a wrong order. It can be understood that if the foolproof hole 821a is not provided, the user still needs to determine the mounting order of film sticking, which will affect the film sticking efficiency. Specifically, in an embodiment, the foolproof hole 821a is different in size from other positioning holes 821, and in the second embodiment, the foolproof hole 821a is different in shape from other positioning holes 821.

Optionally, the foolproof protrusion 231 is configured in a cylindrical shape or in a strip-shaped convex rib shape. The shape of the positioning protrusions 230 may be configured to be round, or may be configured to be square, prismatic or the like, which is not specifically limited here. The obvious cylindrical or strip-shaped convex rib shape is selected to enable the user to clearly distinguish the mounting order of the protective film assembly, and quickly and accurately locate the protective film assembly.

Optionally, the foolproof hole 821a is arranged in a circular shape, or the length of the foolproof hole 821a is larger than those of other positioning holes 821. The shape of the foolproof hole 821a can be configured to be circular, or it can be configured to be square, prismatic or the like, which are not specifically limited here. The selected obvious circular shape or length greater than the length of other positioning holes 821 is intended to enable the user to clearly distinguish the mounting order of the protective film assembly, so as to quickly and accurately position the protective film 500.

The present invention also provides a film sticking assembly, which includes a protective film assembly and a film sticking tool. For the specific structure of the film sticking tool, please refer to the above embodiments. Since this film sticking assembly adopts all the technical schemes of all the above embodiments, it has at least all the beneficial effects brought by the technical schemes of the above embodiments, which will not be repeated here. The protective film assembly includes a protective film and a release film layer which are stacked. The release film layer is provided with a drawing part; one side of the release film layer away from the drawing port of the film sticking box of the film sticking tool is connected to one end of the drawing part; and the other end of the drawing part penetrates the drawing port.

The above are only descriptions for optional embodiments of the present invention, and shall not limit the protection scope of the present invention. Under the inventive concept of the present invention, any equivalent structural transformation made by using the contents of the description and drawings of the present invention or direct/indirect application thereof in other related technical fields shall fall within the patent protection scope of the present invention.

1. A film sticking tool, comprising a film sticking box, wherein the film sticking box comprises a base assembly and a surface shell, the base assembly is provided with a positioning slot, the positioning slot is configured for positioning a device to be stuck with a film, the surface shell is configured for opening or covering the positioning slot, the surface shell is provided with a protective film mounting position for mounting a protective film assembly, a side wall of the film sticking box is provided with a drawing port, and the drawing port is configured for a drawing part on a release film layer of the protective film assembly to penetrate, the drawing port comprises a first notch arranged on the side wall of the surface shell and/or a second notch arranged on the side wall of the bottom shell; by covering the surface shell on the base assembly, the drawing port is closed.

2. The film sticking tool of claim 1, wherein the base assembly comprises a bottom shell and a positioning seat, the bottom shell has a mounting slot facing the surface shell, the positioning seat is arranged in the mounting slot, and the positioning slot is arranged on the positioning seat.

3. The film sticking tool of claim 2, wherein the protective film mounting position is a placing slot formed on the surface shell.

4. The film sticking tool of claim 3; wherein the drawing port comprises a first notch arranged on a side wall of the surface shell and/or a second notch arranged on a side wall of the bottom shell; and/or
a slot bottom of the mounting slot is provided with an indication mark, indication mark is configured for indicating a mounting direction of the device to be stuck with a film, and the slot bottom of the positioning slot is provided with an avoidance opening, and the indication mark is exposed at the avoidance opening; and/or
the surface shell is provided with an operation port penetrating the protective film mounting position.

5. The film sticking tool of claim 2, wherein the film sticking box has a first end and a second end opposite to each other, the surface shell is rotatably connected to the bottom shell at the first end of the film sticking box, and the drawing port is arranged at the second end of the film sticking box.

6. The film sticking tool of claim 5, wherein the surface shell and the bottom shell are rotatably connected by a connector, and the surface shell, the connector and the bottom shell are integrally molded by injection molding, and at least a portion of the connector connected to the surface shell and the bottom shell is thinner than the surface shell and the bottom shell; and/or the surface shell is snap-connected to the bottom shell at the second end of the film sticking box.

7. The film sticking tool of claim 1, wherein the surface shell is provided with a positioning structure at an edge of the protective film mounting position, and the positioning structure is configured for positioning and mounting the protective film assembly.

8. The film sticking tool of claim 7, wherein the positioning structure comprises a plurality of positioning protrusions, two opposite sides of the protective film mounting position are respectively provided with a part of the positioning protrusions, and at least one of the positioning protrusions is configured as a foolproof protrusion, and a cross-sectional size and/or a shape of the foolproof protrusion is different from other of the positioning protrusions.

9. The film sticking tool of claim 8, wherein the foolproof protrusion is configured in a cylindrical shape or in a strip-shaped convex rib shape.

10. A film sticking assembly, comprising:
the film sticking tool of claim 1; and
a protective film assembly, comprising a protective film and a release film layer, wherein the protective film and the release film layer are stacked, the release film layer is provided with a drawing part, one side of the release film layer away from the drawing port of the film sticking box of the film sticking tool is connected to one end of the drawing part, and the other end of the drawing part penetrates the drawing port, the drawing part on the release film layer will automatically enter the drawing port while mounting the protective film assembly.

11. The film sticking assembly of claim 10, wherein the release film layer, comprising one end of the drawing part is connected to the first end of the release film layer, and the other end of the drawing part extends towards the second end of the release film layer.

12. The film sticking assembly of claim 10, wherein the first end of the release film layer is provided with a connecting protrusion.

13. The film sticking assembly of claim 12, wherein the connecting protrusion is provided with a folding line, and a portion of the connecting protrusion can be bent along the folding line, and the bent portion is connected to the drawing part; and/or, the extension section of the drawing part is provided with an indication mark, and the pointing direction of the indication mark is away from the first end of the release film layer.

14. The film sticking assembly of claim 10, wherein the mode of connection between the drawing part and the release film layer is bonding, or the drawing part and the release film layer are integrally molded.

15. (canceled)
